(19) United States
(12) Patent Application Publication
(10) Pub. No.: US 2005/0057801 A1
(43) Pub. Date: Mar. 17, 2005

(54) Talking telescope

(75) Inventor: Rick McWilliams, Ventura, CA (US)

Correspondence Address: Hovey Williams LLP;Suite 400, 2405 Grand Blvd., Kansas City, MO, 64108, US

(73) Assignee: BUSHNELL PERFORMANCE OPTICS

(21) Appl. No.: 10/660,673

(22) Filed: Sep. 11, 2003

(51) Int. Cl. G02B 23/00

(52) U.S. Cl. 359/399; 359/430

(57) ABSTRACT

A talking telescope (10) capable of conveying information to a user both audibly and visually. The telescope (10) may also find and track a specified celestial body (SCB). The telescope (10) broadly comprises an optical telescopic tube (12) for magnifying distant objects, a base (14) for supporting the telescope, a cradle (16) for securing the tube (12) to the base (14), a drive mechanism (18) for moving the tube (12) with respect to the base (14), and a controller (20) for allowing the user to interact with the telescope (10). The controller (20) includes a database to store information relating to a plurality of celestial bodies and a processor (24) to access the information in the database relating to the SCB. The controller (20) also preferably includes a speaker (28) to audibly convey the information and a display (30) to visually convey the information.

### BACKGROUND OF THE INVENTION

1. Field of the Invention

The present invention relates to telescopes. More particularly, the present invention provides a talking telescope capable of conveying information to a user both audibly and visually.

2. Description of Prior Art

Telescopes are commonly used to view distant objects, such as stars or other celestial bodies. Telescopes typically use optical tubes to magnify stars that might not otherwise be visible.

It is often desirable to learn more about a particular star than can be discerned simply by viewing the star. To this end, some telescopes can be wired to computers, thereby providing some advanced functionality. For example, computers may be able to audibly convey information about stars while users view the stars. However, in order to provide such functionality, computers must be wired to telescopes and must be configured to run specialized software. Wiring and configuring computers can be difficult for many people.

Additionally, cabling required to connect telescopes to computers can interfere with operation of the telescopes. For example, the cabling may become tangled around the telescopes. Thus, such telescopes can be difficult to prepare and troublesome to use.

Accordingly, there is a need for an improved telescope that overcomes the limitations of the prior art.

### SUMMARY OF THE INVENTION

The present invention overcomes the above-identified problems and provides a distinct advance in the art of telescopes. More particularly, the present invention provides a talking telescope capable of conveying information to a user both audibly and visually. Additionally, the telescope may automatically find and track stars or other celestial bodies specified by the user. The telescope broadly comprises an optical telescopic tube for magnifying distant objects, a base for supporting the tube, a cradle for securing the tube to the base, a drive mechanism for moving the tube with respect to the base, and a controller for allowing the user to interact with the telescope.

The controller is preferably internal to the telescope. For example, the controller may be housed in an enclosure mated to the tube. Alternatively, the enclosure may be mated to the base or the cradle. In any case, the controller allows the user to interact with the telescope, such as by conveying the information to the user, while not requiring cabling between the telescope and the controller. Thus, there is nothing to interfere with the operation of the telescope by becoming tangled in the drive mechanism.

The controller preferably includes a database to store information relating to a plurality of celestial bodies and a processor to control the drive mechanism in order to align the tube with a specified celestial body (SCB) and access the information in the database relating to the SCB. The information also preferably includes details relating to each celestial body, such as location information. More specifically, the location information preferably comprises an orbital path of each celestial body with respect to some reference point.

The information stored in the database may also include text files containing verbal descriptions of the celestial bodies, astronomical information, and statistical or scientific information. Additionally, the information stored in the database may include graphics files containing pictures of the celestial bodies, diagrams of groups of celestial bodies, and charts or other visual information.

The processor preferably stores the telescope's location and orientation, as well as a date. Using the location information relating to the SCB, the telescope's location, and the date, the processor calculates a bearing to the SCB with respect to the telescope. Then, the processor aligns the tube with the SCB by orienting the tube along the bearing. In this manner, the processor allows the user to view the SCB through the tube.

The processor also conveys some portion of the information stored in the database to a user. In order to facilitate conveying the information, the controller also preferably includes a speaker or other audio device. For example, the processor converts a text file associated with the SCB into an audio signal representative of audible speech. The processor then sends the audio signal to the speaker. In turn, the speaker converts the audio signal into audible speech. In this manner, the telescope may use the speaker to audibly convey the information stored in the database and associated with the SCB.

The controller may also include a display, such as a liquid crystal display, a cathode ray tube display, or another computer-controlled display. In this case, the processor converts a graphics file associated with the SCB into a video signal representative of the graphics file. The processor then sends the video signal to the display. In turn, the display presents the graphics file to the user. In this manner, the telescope may use the display to visually convey the information stored in the database and associated with the SCB.

Additionally, the controller may include a handheld remote control with a screen and a plurality of buttons allowing the user to interact with the telescope. For example, the user may provide the processor with the telescope's location and orientation using the remote control. Alternatively, the user may assist the processor in determining the telescope's location and/or orientation using the remote control. Furthermore, the user may choose the SCB from the celestial bodies stored in the database using the remote control.

In use, a user may provide the telescope's location and orientation using the remote control. The user may then choose a SCB from the celestial bodies stored in the database. The processor then searches the database for information relating to the SCB. Using the location information relating to the SCB and the telescope's location, the processor 24 calculates the bearing to the SCB. Then, the processor aligns the tube along the bearing. Finally, the processor generates the audio and video signals for the speaker and the display, respectively. At this point, the user can view the SCB through the tube, hear information relating to the SCB through the speaker, and see information relating to the SCB on the display.

### BRIEF DESCRIPTION OF THE DRAWINGS

A preferred embodiment of the present invention is described in detail below with reference to the attached drawing figures, wherein:

FIG. 1 is a perspective view of a talking telescope constructed in accordance with a preferred embodiment of the present invention;

FIG. 2 is a block diagram of a controller of the telescope; and

FIG. 3 is flow chart showing a preferred location determination procedure used by the telescope.

### DETAILED DESCRIPTION OF A PREFERRED EMBODIMENT

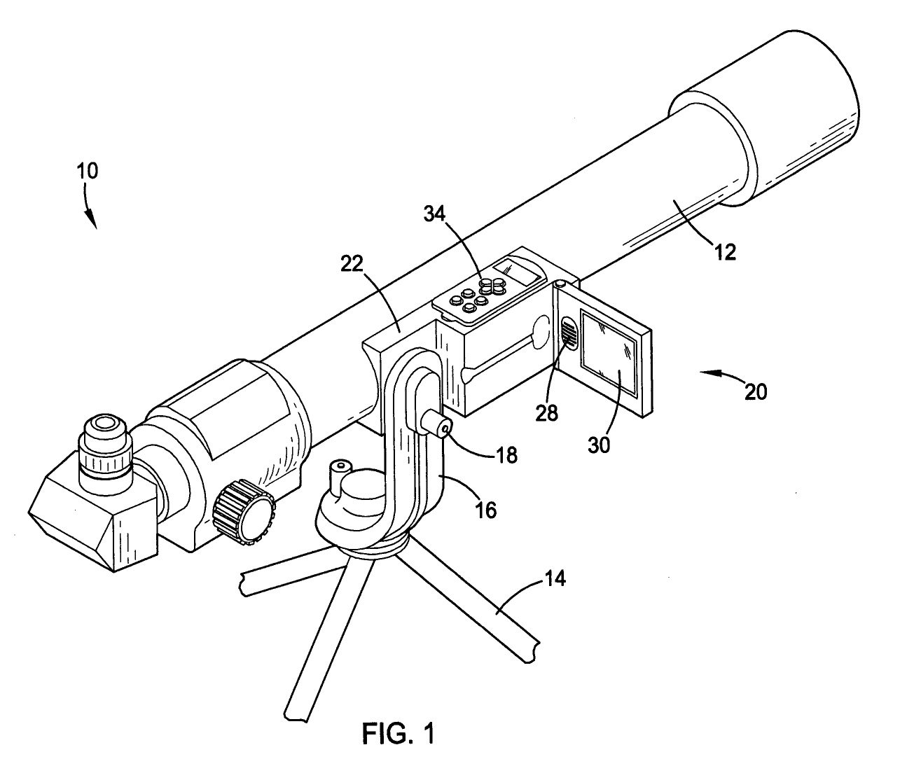

Referring to FIG. 1, a telescope 10 constructed in accordance with a preferred embodiment of the present invention is illustrated as a stand-alone system capable of conveying information to a user both audibly and visually. Additionally, the telescope 10 may automatically find and track stars or other celestial bodies specified by the user. As such, the telescope 10 of the present invention preferably incorporates capabilities shown in “FULLY AUTOMATED TELESCOPE SYSTEM WITH DISTRIBUTED INTELLIGENCE”, U.S. Pat. No. 6,392,799, hereby incorporated into the present application by reference.

The telescope 10 broadly comprises an optical telescopic tube 12 for magnifying distant objects, a base 14 for providing a stable platform for the tube 12, a cradle 16 for securing the tube 12 to the base 14, a drive mechanism 18 for moving the tube 12 with respect to the base 14, and a controller 20 for allowing the user to interact with the telescope 10.

The tube 12 is preferably conventional with manual focus and zoom functions. The tube 12 may be either a refractor-type tube or a reflector-type tube. Additionally, the tube 12 preferably comprises an objective lens mounted to a distal end and a eyepiece mounted to a proximal end. For example, the tube 12 may be similar to that found in Bushnell's Voyager series of telescopes. Alternatively, the tube 12 may incorporate automatic focus or automatic zoom functions controlled by the controller 20.

The base 14 is preferably a conventional tri-pod, but may be a base-plate designed to be mounted to a support surface. The cradle 16 may comprise a conventional yoke mounting assembly or another support assembly that allows the tube 12 to move with respect to the base 14. For example, the cradle 16 preferably swivels with respect to the base 14, while the tube 12 preferably pivots up and down with respect to the cradle 16. Thus, the base 14 and the cradle 16 provide the tube 12 with stable support, while allowing the tube 12 to articulate with respect to two-axis.

The drive mechanism 18 preferably comprises a plurality of stepper motors to govern a pitch angle and an azimuth angle of the tube 12 with respect to the base 14. For example, the drive mechanism 18 may be similar to that found in Bushnell's North Star series of telescopes. The drive mechanism 18 may also include gears and other components commonly found in telescope drive mechanisms.

The controller 20 is preferably housed in an enclosure 22 mated to the tube 12. Alternatively, the enclosure 22 may be mated to the base 14 or the cradle 16. In any case, the controller 20 allows the user to interact with the telescope 10, such as by conveying the information to the user, while not requiring cabling between the telescope 10 and the controller 20. Thus, there is nothing to interfere with the operation of the telescope 10 by becoming tangled in the drive mechanism 18.

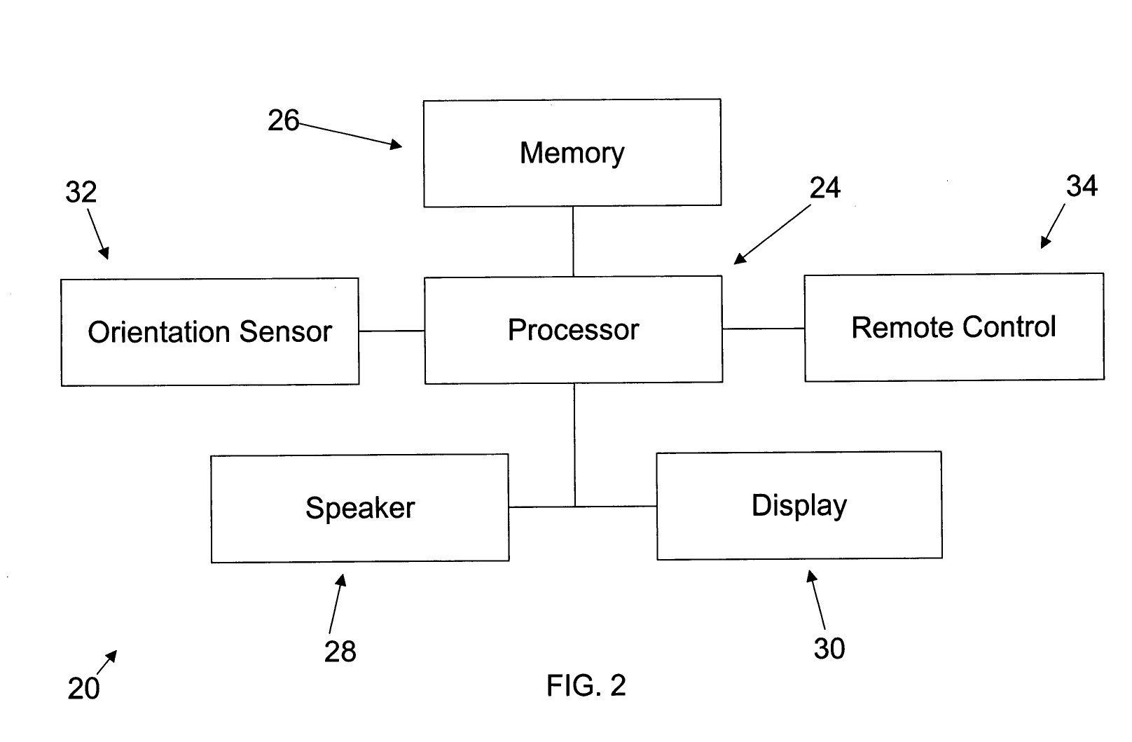

Referring to FIG. 2, the controller 20 preferably includes a processor 24 to control the drive mechanism 18 in order to align the tube 12 with a specified celestial body (SCB) and a memory device 26 to store a database with information relating to a plurality of celestial bodies. As will be discussed in more detail below, the user preferably identifies the SCB and the processor 24 then accesses the information in the database relating to the SCB. The information preferably includes details relating to each celestial body, such as location information. More specifically, the location information preferably comprises an orbital path of each celestial body with respect to some reference point, such as the sun. Alternatively, the location information may be relational, such that each celestial body's location is described in relation to other celestial bodies. The celestial bodies may be stars, constellations, planets, and/or other named objects.

Additionally, the information stored in the database may include text files. For example, the text files may contain verbal descriptions of the celestial bodies, such as descriptions concerning each celestial body's appearance. The text files may also contain astronomical information, such as orbital paths and velocities along those paths, as well as statistical or scientific information.

Furthermore, the information stored in the database may include graphics files. For example, the graphics files may include pictures of the celestial bodies taken from earth or from a satellite. The graphics files may also contain diagrams of groups of celestial bodies, as well as charts or other visual information.

As discussed above, the processor 24 accesses the database in order to retrieve information relating to the SCB. The processor 24 also preferably stores the telescope's 10 location and orientation, as well as a date. Using the location information relating to the SCB, the telescope's location, and the date, the processor 24 calculates a bearing to the SCB with respect to the telescope 10. Then, the processor 24 aligns the tube 12 with the SCB by orienting the tube 12 along the bearing using the drive mechanism 18. In this manner, the processor 24 allows the user to view the SCB through the tube 12.

The processor 24 also conveys some portion of the information stored in the database to the user. In order to facilitate conveying the information, the controller 20 also preferably includes a speaker 28 or other audio device. For example, the processor 24 converts one of the text files associated with the SCB into an audio signal representative of audible speech. The processor 24 then sends the audio signal to the speaker 28. In turn, the speaker 28 converts the audio signal into audible speech. In this manner, the telescope 10 may use the speaker 28 to audibly convey the information stored in the database and associated with the SCB.

The audible speech is preferably in English, but may be in other languages, such as French, Spanish, or German. The database and/or the processor 24 may be operable to use more than one of the languages. Alternatively, the database and/or the processor 24 may be configured to use only one of the languages. For example, the telescope 10 may be configured for a selected language, such as English. Alternatively, the user may pick the selected language from a language list in order to configure the processor 24 to generate the audio signal such that the speaker 28 produces the audible speech in the selected language.

The controller 20 may also include a display 30, such as a liquid crystal display, a cathode ray tube display, or another computer-controlled display. In this case, the processor 24 converts one of the graphics files associated with the SCB into a video signal representative of the graphics file. The processor 24 then sends the video signal to the display 30. In turn, the display 30 presents the graphics file to the user. In this manner, the telescope 10 may use the display 30 to visually convey the information stored in the database and associated with the SCB.

Additionally, the display 30 may show the SCB, as viewed through the tube 12. For example, the database may contain an image of each celestial body, which may be presented on the display 30. In this case, the processor 24 retrieves the image associated with the SCB from the database and sends the image to the display 30.

Alternatively, the telescope 10 may include a charge-coupled device (CCD) camera or other video device. The camera is preferably securely aligned with the tube 12 and may be secured to the tube 12 or the cradle 16. In fact, the camera and the tube 12 preferably share substantially identical fields of view. In this case, the display 30 may substantially continuously present a digital photo or movie of the tube's 12 field of view, as taken by the camera.

Furthermore, the display 30 may present text from the text file associated with the SCB. Thus, the information conveyed through the speaker 28 may be substantially identical to that conveyed through the display 30. For example, the audible speech may simply be an oral recitation of text presented on the display 30. Alternatively, the speaker 28 may be used to convey textual information while the display 30 conveys graphical information.

As discussed above, the memory device 26 is accessible by the processor 24. In fact, the memory device 26 may be internal to and form part of the processor 24. Alternatively, the memory device 26 may be of any commonly used computer memory type. Furthermore, the memory device 26 may be removable. For example, the memory device 26 may be of the type commonly used in portable electronics, such as a compact flash memory card or a secure digital memory card. In this case, the user may replace the database by simply replacing the memory device 26. The user may also pick the selected language by simply replacing the memory device 26.

The controller 20 may also include an orientation sensor 32 to assist the processor 24 in orienting the tube 12 along the bearing. Additionally, the orientation sensor 32 may assist the processor 24 in determining the orientation of the tube 12. The orientation sensor 32 is preferably securely aligned with the tube 12 and may be secured to the tube 12 or the cradle 16. In fact, the orientation sensor 32 and the tube 12 preferably share substantially identical orientations.

The orientation sensor 32 preferably comprises a two-axis accelerometer and a two-axis flux-gate magnetometer. The combination of the accelerometer and the magnetometer enables the orientation sensor 32 to determine the pitch and azimuth angles of the orientation sensor 32 and the tube 12. The accelerometer is first used to determine the pitch angle by measuring the Earth's gravity. Once the pitch angle is known, the magnetometer is used to determine the azimuth angle, which is defined by horizontal components of the Earth's local magnetic field. In this manner, the orientation sensor 32 determines the orientation of the telescope 10.

The orientation sensor 32 preferably generates an orientation signal representative of the pitch and azimuth angles. Therefore, when the tube 12 is pointed at a particular object, the orientation signal is preferably representative of a particular bearing comprising the pitch and azimuth angles between the telescope 10 and the particular object.

Additionally, the controller 20 may include a handheld remote control 34 with a screen and a plurality of buttons allowing the user to interact with the telescope 10. For example, the user may provide the processor 24 with the telescope's 10 location and orientation using the remote control 34. Alternatively, the user may assist the processor 24 in determining the telescope's 10 location and/or orientation using the remote control 34. Furthermore, the user may choose the SCB from the celestial bodies stored in the database using the remote control 34. Finally, the user may pick the selected language from the language list using the remote control 34. The remote control 34 preferably communicates with the controller 20 over a wireless connection.

While the present invention has been described above, it is understood that substitutions may be made. For example, the remote control 34 may be an integral part of the controller 20. Additionally, the speaker 28 and/or the display 30 may be incorporated into the remote control 34. These and other minor modifications are within the scope of the present invention.

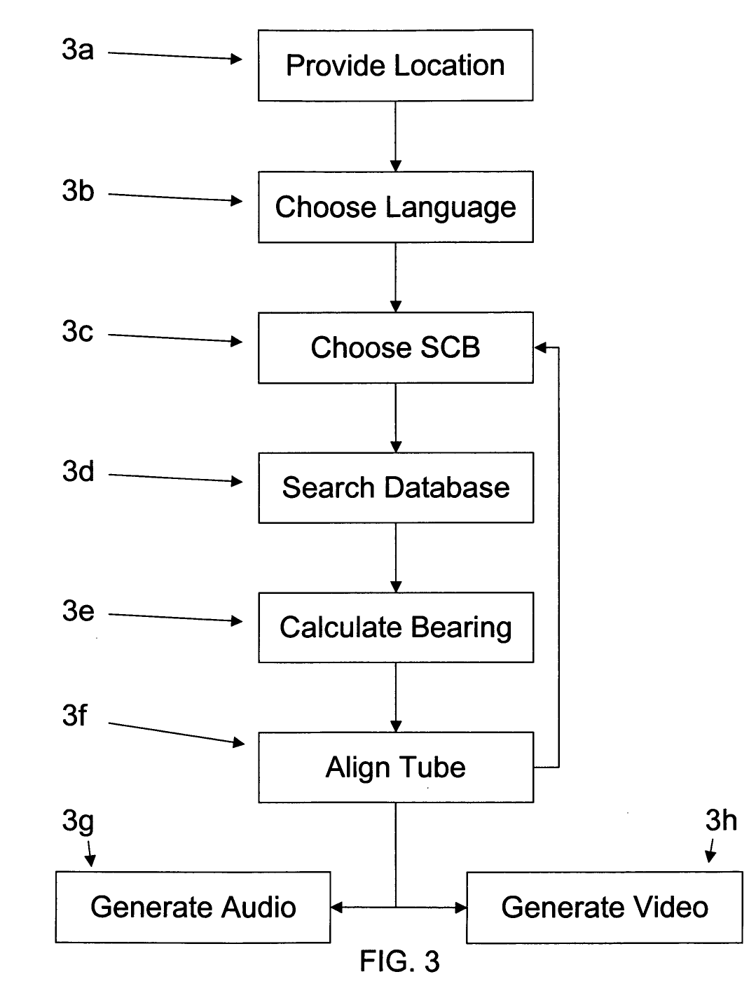

The flow chart of FIG. 3 shows the functionality and operation of a preferred implementation of the present invention in more detail. In this regard, some of the blocks of the flow chart may represent a module segment or portion of code of a program of the present invention which comprises one or more executable instructions for implementing the specified logical function or functions. In some alternative implementations, the functions noted in the various blocks may occur out of the order depicted. For example, two blocks shown in succession may in fact be executed substantially concurrently, or the blocks may sometimes be executed in the reverse order depending upon the functionality involved.

In use, as shown in FIG. 3, the user may provide the telescope's 10 location and orientation using the remote control 34, as depicted in step 3a. The user may then pick the selected language using the remote control 34, as depicted in step 3b. With the telescope 10 configured in this manner, the user may then choose the SCB from the celestial bodies stored in the database, as depicted in step 3c. The processor 24 then searches the database for information relating to the SCB, as depicted in step 3d.

Using the location information relating to the SCB, the processor 24 calculates the bearing to the SCB, as depicted in step 3e. Then, the processor 24 aligns the tube 12 along the bearing, as depicted in step 3f. Finally, the processor 24 generates the audio and video signals for the speaker 28 and the display 30, respectively, as depicted in steps 3g and 3h. At this point, the user can view the SCB through the tube 12, hear information relating to the SCB through the speaker 28, and see information relating to the SCB on the display 30. Furthermore, the user may choose another SCB. In this case, the processor 24 repeats steps 3d through 3h for the new SCB.

Having thus described a preferred embodiment of the invention, what is claimed as new and desired to be protected by Letters Patent includes the following:

1. A telescope operable to audibly convey information relating to a selected one of a plurality of celestial bodies, the telescope comprising:
a telescopic tube operable to optically magnify the selected celestial body;
a processor operable to generate an audio signal;
a memory device storing a database operable to contain information relating to the plurality of celestial bodies and accessible by the processor;
an audio device operable to convert the audio signal into audible speech, thereby audibly conveying the information in the database relating to the selected celestial body; and
an enclosure housing the processor, the memory device, and the audio device.

2. The telescope as set forth in claim 1, wherein the audio device comprises a speaker.

3. The telescope as set forth in claim 1, further including an orientation sensor operable to determine an orientation of the tube in order to assist the processor in matching the object with the celestial body.

4. The telescope as set forth in claim 1, wherein the processor is further operable to generate a video signal in order to visually convey the information relating to the selected celestial body.

5. The telescope as set forth in claim 4, further including a display operable to convert the video signal into graphics.

6. The telescope as set forth in claim 5, wherein the display and the speaker convey substantially identical information.

7. The telescope as set forth in claim 5, wherein the speaker and the display convey substantially different information such that the display and the speaker supplement each other.

8. The telescope as set forth in claim 1, further including a base operable to support the tube, a cradle attached to the base and operable to movably secure the tube to the base, and a drive mechanism operable to move the cradle with respect to the base.

9. The telescope as set forth in claim 8, wherein the processor is further operable to align the tube with the selected celestial body using the drive mechanism.

10. The telescope as set forth in claim 1, further including a remote control operable to facilitate a user providing the processor with the telescope's location.

11. The telescope as set forth in claim 1, wherein the processor is further operable to generate the audio signal such that the audible speech is produced in a selected one of a plurality of languages.

12. The telescope as set forth in claim 11, further including a remote control operable to facilitate the user picking the selected language.

13. A talking telescope operable to audibly convey information relating to a selected one of a plurality of celestial bodies and bring the selected celestial body within the telescope's field of view, the telescope comprising:
a telescopic tube operable to optically magnify the selected celestial body;
a drive mechanism operable to align the tube with the selected celestial body;
a processor operable to control the drive mechanism and generate an audio signal;
a memory device storing a database operable to contain information relating to the plurality of celestial bodies and accessible by the processor;
a speaker operable to convert the audio signal into audible speech, thereby audibly conveying the information in the database relating to the selected celestial body; and
an enclosure integral to the telescope and housing the processor, the memory device, and the speaker.

14. The telescope as set forth in claim 13, further including an orientation sensor operable to determine an orientation of the tube in order to assist the processor in aligning the tube with the selected celestial body.

15. The telescope as set forth in claim 13, wherein the processor is further operable to generate the audio signal such that the audible speech is produced in one of a plurality of languages.

16. The telescope as set forth in claim 13, wherein the processor is further operable generate a video signal in order to visually convey the information relating to the selected celestial body.

17. The telescope as set forth in claim 16, further including a display operable to convert the video signal into graphics.

18. The telescope as set forth in claim 17, wherein the speaker and the display convey substantially identical information.

19. The telescope as set forth in claim 17, wherein the speaker and the display convey substantially different information such that the speaker and the display supplement each other.

20. A talking telescope operable to convey information relating to a selected one of a plurality of celestial bodies and bring the selected celestial body within the telescope's field of view, the telescope comprising:
a telescopic tube operable to optically magnify the selected celestial body;
a base operable to support the tube;
a cradle attached to the base and operable to movably secure the tube to the base;
a drive mechanism operable to move the cradle with respect to the base in order to align the tube with the selected celestial body;
a controller operable to allow a user to interact with the telescope, the controller comprising
a memory device storing a database operable to contain textual and graphical information relating to the celestial bodies,
a processor operable to align the tube with the selected celestial body using the drive mechanism, generate an audio signal in order to audibly convey the textual information relating to the selected celestial body, and generate a video signal in order to visually convey the graphical information relating to the selected celestial body,
an orientation sensor operable to determine an orientation of the tube in order to assist the processor in aligning the tube with the selected celestial body,
a speaker operable to convert the audio signal into audible speech, and
a display operable to convert the video signal into graphics; and
an enclosure integral to the telescope and housing the controller.
